(19) United States
(12) Patent Application Publication
(10) Pub. No.: US 2022/0024026 A1
(43) Pub. Date: Jan. 27, 2022

(54) DOOR OPENER MULTITOOL

(71) Applicant: Michael V. Smeja, Inverness, IL (US)

(72) Inventor: Michael V. Smeja, Inverness, IL (US)

(73) Assignee: Limitless Innovations, Inc., McHenry, IL (US)

(21) Appl. No.: 16/938,703

(22) Filed: Jul. 24, 2020

(51) Int. Cl. B25J 1/04; B25B 9/02; A44B 15/00; G06F 3/0354

(52) U.S. Cl. CPC B25J 1/04; G06F 3/03545; A44B 15/005; B25B 9/02

(57) ABSTRACT

The present invention is related to a door opener multitool. The door opener multitool includes an opener member and a case member. The opener member and the case member are removably attached. A recess in a middle member of the opener member engages a pair of raised members on the case member to secure the opener member to the case member. A user may hold the opener member from the handle, and use the hook to grab door handle, drawer handle or the like to open such devices without directly contacting those surfaces. Such configuration allows an extra level of hygiene by allowing the user to avoid contacting frequently touched surfaces. The tip may also include a blunt end sized to push buttons. The case member allows hygienic and safe storage of the door opener multitool.

### FIELD OF THE INVENTION

This invention relates to a door opener multitool apparatus. More particularly, this invention relates to a device that allows for contactless control of doors and other movable objects, carrying of bags, as well as contactless activation of buttons, having an ergonomic grip and a case for secure and sanitary storage.

### SUMMARY OF THE INVENTION

Recent health crises have highlighted the importance of personal hygiene, and difficulty in personal avoidance of infectious microbes in public places with frequent traffic. Door handles, elevator buttons, point of sale (POS) machines, etc. are places where people frequently touch. Even with frequent disinfection and cleaning, such surfaces are quickly contaminated with variety of viruses, bacteria, and other potentially harmful microbes, and are difficult to maintain in sufficient sanitation levels. A variety of tools have been used in hospitals and other high traffic and high exposure locations. However, many of the prior tools require a semi-permanent fixture, such as elbow hold or foot opener, on the door for people to use. Many public places do not have such fixtures. Furthermore, these public fixtures may themselves be contaminated.

U.S. Patent Publication No. 2020/0086477 describes a “compact and portable door pull for sanitary use.” Id. at ¶ 32. The '477 publication discloses a single piece device with an extension embodiment and a single piece device with a flip out/rotate out embodiment. Both of the embodiments disclosed in the '477 publication require the user to grip the handle in sufficient force and does not address the problem where a user's hand may slip from the handle.

Furthermore, the embodiments disclosed in the '477 publication are bulkier in light of the additional mechanism required to extend or rotate the hook feature. In addition, the embodiments disclosed in the '477 publication contain extraneous pieces extending out of the device that may be caught on clothing or other items while the device is not in use.

### SUMMARY OF THE INVENTION

The present invention is directed to a system and apparatus that enables a user to handle movable objects, such as doors or drawers, which are frequently touched by multiple people. Such surfaces are likely to collect extra germs from frequent contact by other people. The present system and apparatus provide a personal device to the user to control exposed objects without personally being exposed to infectious microbes on those objects. The integrally provided case further provides for secure and sanitary storage of the device. Specifically, the case contains the contact surfaces of the device to prevent any microbes transferred from a surface to the device from then being transferred to a user's pocket, bag or purse, and thus cross-contaminating the user. The case also prevents the device from being caught in loose objects or clothing. The present invention further provides a grip mechanism that enables the user to operate heavier objects without loss of grip. In a preferred embodiment, the contact portion of the device is made of a copper alloy, which has natural anti-microbial properties to help sanitize the device and kill microbes that come in contact with it. The integral provided case may also be manufactured with an additive to provide the case itself with antimicrobial properties.

### BRIEF DESCRIPTION OF THE DRAWINGS

Reference may now be had to the following detailed description taken together with the accompanying drawings in which:

FIG. 1 is a perspective view of the assembled door opener multitool according to a preferred embodiment of the present invention.

FIG. 2 is a perspective view of the opener member of the door opener multitool of FIG. 1.

FIG. 3 is a front view of the opener member of the door opener multitool of FIG. 1.

FIG. 4 is a top view of the opener member of the door opener multitool of FIG. 1.

FIG. 5 is a perspective view of the case member of the door opener multitool of FIG. 1.

FIG. 6 is a front view of the case member of the door opener multitool of FIG. 1.

FIG. 7 is a top view of the case member of the door opener multitool of FIG. 1.

FIG. 8 is a cross section view of the case member of the door opener multitool of FIG. 1.

FIG. 9 is a close up detail view of the case member of the door opener multitool of FIG. 1.

FIG. 10 is a perspective view of the assembled door opener multitool of FIG. 1.

FIG. 11 is a side view of the assembled door opener multitool of FIG. 1.

FIG. 12 is a top view of the assembled door opener multitool of FIG. 1.

FIG. 13 is a cross section view of the assembled door opener multitool of FIG. 12 along line A-A.

FIG. 14 is a cross section close up view of the assembled door opener multitool of FIG. 13 along line B-B.

### DETAILED DESCRIPTION OF THE DRAWINGS

Exemplary embodiments of the invention will now be described in relation to the figures. Persons having ordinary skill in the relevant field will understand that use of the directional words such as up, down, left, and right, refers to the direction of the properly oriented figure, and it is not otherwise intended to be limiting.

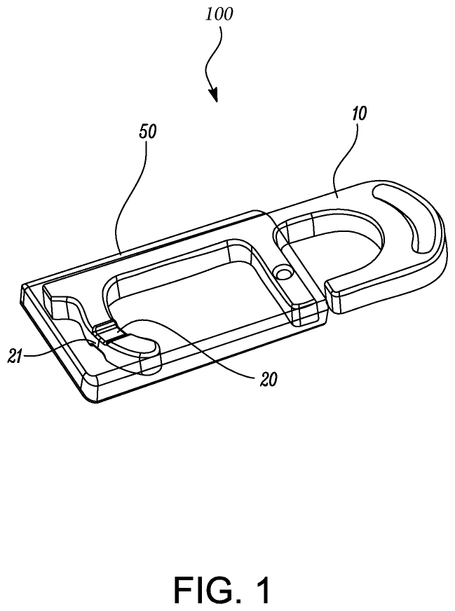

FIG. 1 illustrates a perspective view of the assembled door opener multitool 100 according to a preferred embodiment of the present invention. The door opener multitool 100 includes an opener member 10 and a case member 50. The opener member 10 and the case member 50 are removably attached. As will be explained further in detail below, a recess 15 (not shown in FIG. 1) in a middle member 12 (not shown in FIG. 1) engages a pair of raised members 26 (not shown in FIG. 1) to secure the opener member 10 to the case member 50.

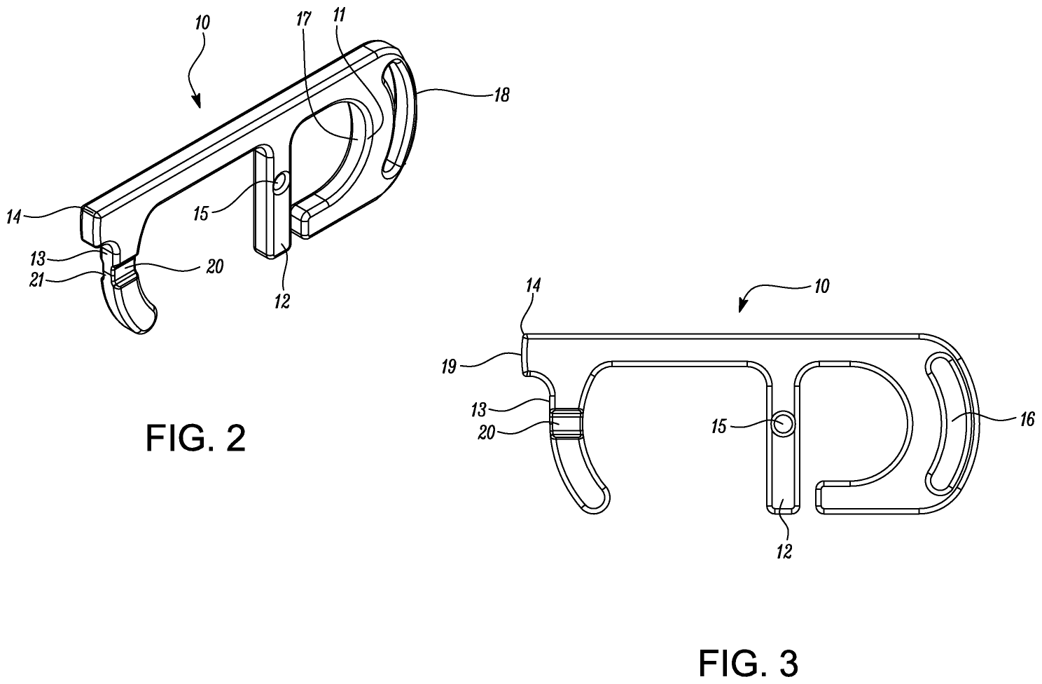

FIG. 2 is a perspective view of the opener member 10 of the door opener multitool 100 shown in FIG. 1. The opener member 10 includes a handle 11, a middle member 12, a hook 13, and a tip 14. The handle 11 includes a slot 16. The handle 11 includes a curved inner surface 17 and a curved outer surface 18. The curved inner surface 17 and the curved outer surface 18 are shaped roughly semi-circular. In alternative embodiments, the curved inner surface 17 and the curved outer surface 18 may have an elliptical shape. The curvature of the curved inner surface allows a user's finger to settle within the space created by the curved inner surface 17 and the middle member 12. The shape of the curved inner surface 17 also allows a more secure grip by the user without slipping. Similarly, the curved outer surface 18 rests within the users palm and provides an increased grip. The slot 16 may be used to attach a key ring, or other connections to secure the opener member 10. The middle member 12 includes a recess 15. As shown in the embodiment in FIG. 2, the recess 15 can be a through hole passing through the middle member. In alternative embodiments, the middle member 12 may include a second recess on the opposing side of the middle member 12. The second recess may be centrally aligned with the recess 15. In further alternatives, the second recess may not be aligned with the recess 15 and may be placed along the length of the middle member 12. The recess 15 may have a circular shape. In alternative embodiments, the recess 15 may have any other shape, such as rectangular or elliptical. As described further below, the recess 15 is used to attach opener member 10 to the case member 50.

The hook 13 may include a pair of channels 20/21 placed in opposing sides of the hook 13. The pair of channels 20/21 has a depth of at least the length of a pair of raised members 55/56 (which are shown and described in relation to FIG. 5). In the preferred embodiment, the pair of channels 20/21 is at least as wide as the pair of raised members 55/56. However, in alternative embodiments, the pair of channels 20/21 may be wider than the pair of raised members 55/56. The relationship of the pair of channels 20/21 with the pair of raised members 55/56 is described below in relation to FIG. 10.

A user may hold the opener member 10 from the handle 11, and use the hook 13 to grab door handle, drawer handle or the like to open such devices without directly contacting those surfaces. Similarly, the user could secure the hook 13 around the handle of a bag to pick up a bag. Such configuration allows an extra level of hygiene by allowing the user to avoid contacting frequently touched surfaces. The tip 14 extends from an end of the device past the hook 13. The tip 14 has a blunt end 19 that is sized to push buttons, such as elevator buttons or point of sale terminal buttons. The blunt end 19 preferably lacks sharp edges or corners that could crack or scratch a touch screen or button covering. In alternative embodiments, the blunt end 19 may be made of polymers, such as rubber, or other soft materials to reduce the impact of the blunt end 19 on touch screens or buttons. In other alternatives, the blunt end 19 may be formed in a different shape, such as rounded.

In one embodiment, the opener member 10 may be manufactured from conductive material. In such embodiment, the opener member 10 may conduct the electrical charge from the user's hand to capacitive screens to allow the user to control such screens and other touch screen buttons. In other alternatives, the device could be made from a conductive polymer.

FIG. 3 is a front view of the opener member 10 of the door opener multitool 100.

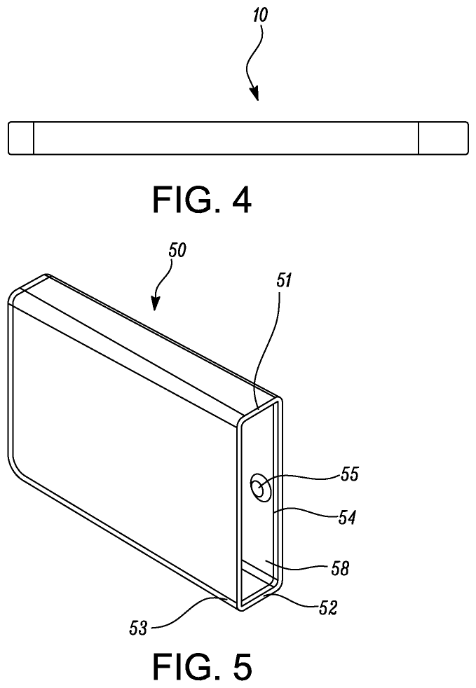

FIG. 4 is a top view of the opener member 10 of the door opener multitool 100.

FIG. 5 is a perspective view of the case member 50 of the door opener multitool 100. The case member 50 includes a top wall 51, a bottom wall 52, a front wall 53, and a back wall 54. The case member also includes a side wall (not shown). Together, the top wall 51, the bottom wall 52, the front wall 53, the back wall 54 and the side wall form a pocket 57. The pocket 57 has an opening 58 formed by edges of top wall 51, bottom wall 52, front wall 53 and back wall 54. The walls are sized in relation to the opener member 10 to house the hook section of the opener member 10. The front wall 53 and the back wall 54 include a pair of raised members 55/56 (only raised member 56 shown). The raised members 55/56 are located on the front wall 53 and the back wall 54, respectively, and are sized and positioned in relation to the recess 15 located in the middle member 12 of the opener member 10. In the shown embodiment, the raised members are proximate the opening 58.

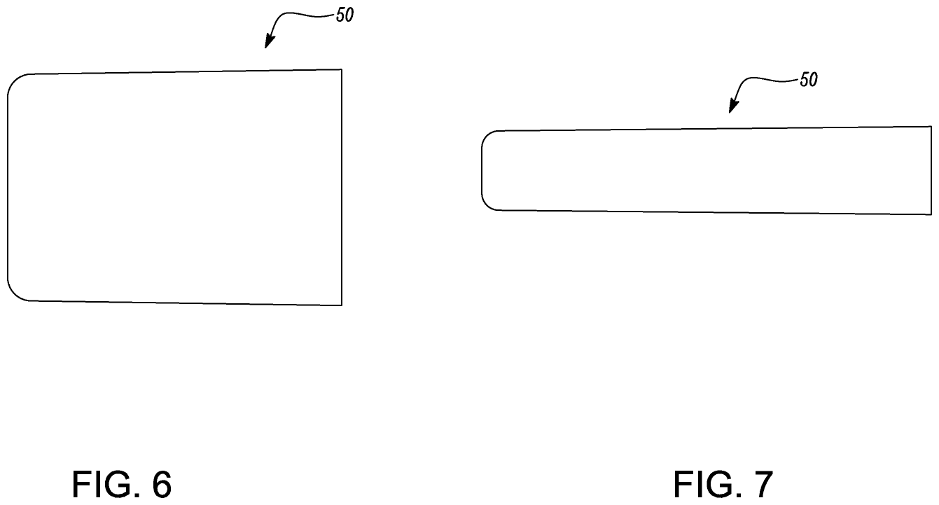

FIG. 6 is a front view of the case member 50 of the door opener multitool 100.

FIG. 7 is a top view of the case member 50 of the door opener multitool 100.

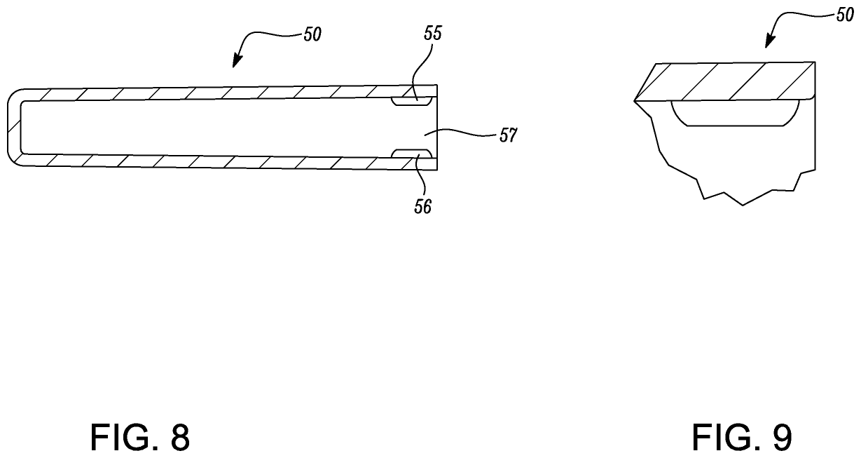

FIG. 8 is a cross section view of the case member 50 of the door opener multitool 100. As seen in FIG. 8, the case member 50 includes the pair of raised members 55/56 located substantially opposite each other on opposite walls. Furthermore, the walls create a pocket 57 to receive the opener member 10. As discussed further below, the raised members secure the opener member 10 within case member 50.

FIG. 9 is a close-up detail view of the raised member 55 of the case member 50 of the door opener multitool 100. As shown in this embodiment, the raised member 55 is a rounded member extending from the inside surface of back wall 54. It will be understood by one of skill in the art that raised member 56 will have a similar appearance and structure. In other alternatives, the raised members 55/56 may have differing appearance and structure.

FIG. 10 is a perspective view of the assembled door opener multitool 100. The pieces of the door opener multitool 100, the opener member 10 and the case member 50 may be provided to the user either assembled or disassembled.

In order to place the opener member 10 within the case member 50, a user inserts the hook 13 end of the opener member 10 into the pocket 57 of the case member 50 via the opening 58. The pair of channels 20/21 located on the hook 13 allows the hook 13 to pass over the pair of raised members 55/56 with less obstruction. The pair of channels 20/21 manufactured in a way to align with the pair of raised members 55/56. The shape and the dimensions of the pair of channels 20/21 may differ in alternative embodiments so long as the pair of raised members pass through the hook 13 with less obstruction. The opener member 10 and the case member 50 are manufactured in a way to align the pair of raised members 55/56 and the recess 15. When sufficient force is applied to the opener member 10 towards to case member 50, the raised members 55/56 snap into the recess 15 and retains the opener member 10 within the case member 50. When engaged, the opener member 10 remains attached to the case member 50. The engagement is not permanent. In order to disengage the raised members 55/56 from the recess 15, a user applies sufficient force to the opener member 10 and the case member 50 in opposing directions.

The case member 50 is preferably made from a polymer with an antibacterial additive. The antibacterial additive is preferably an inorganic antibacterial powder capable of reducing the concentration of substances of very high concern to less than %0.01 weight/weight. In the preferred embodiment, the antibacterial additive is silver ion. In other alternative embodiments, other antibacterial additives may be used instead of silver ion so long as a similar level of disinfection can be achieved. When the opener member 10 is stored in the case member 50, the case member 50 passively disinfects the opener member 10. In alternative embodiments, a more or less effective additive may be used in order to reach a desired level of disinfection. Higher level of disinfection may be desired where the use of the door opener multitool 100 is likely to encounter higher concentration of contaminants. In alternative embodiments, the opener member 10 may also be made from a polymer with the antibacterial additive.

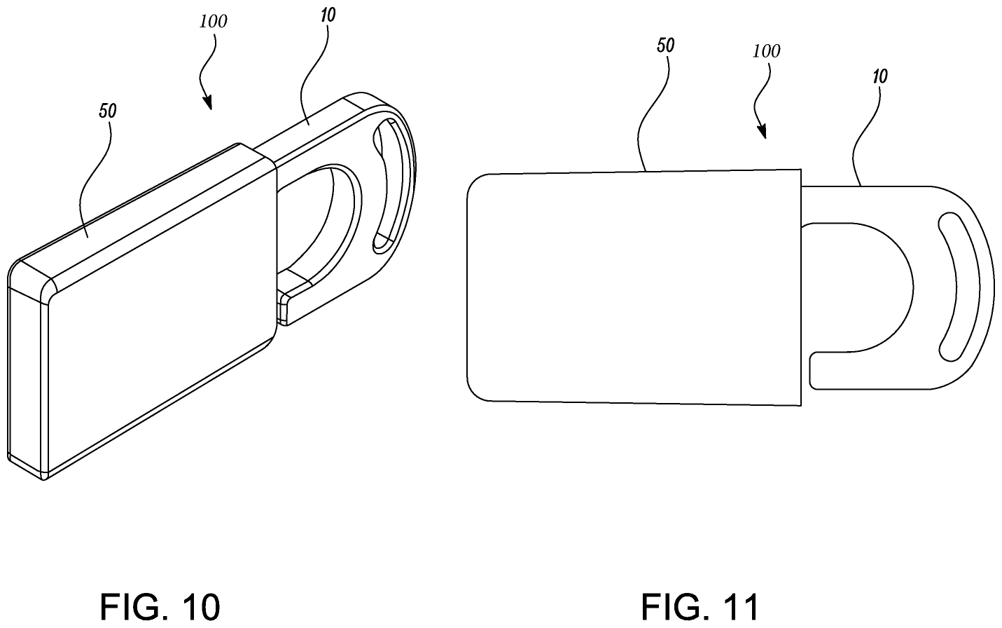

FIG. 11 is a side view of the assembled door opener multitool 100 and shows the opener member 10 snapped into the case member 50.

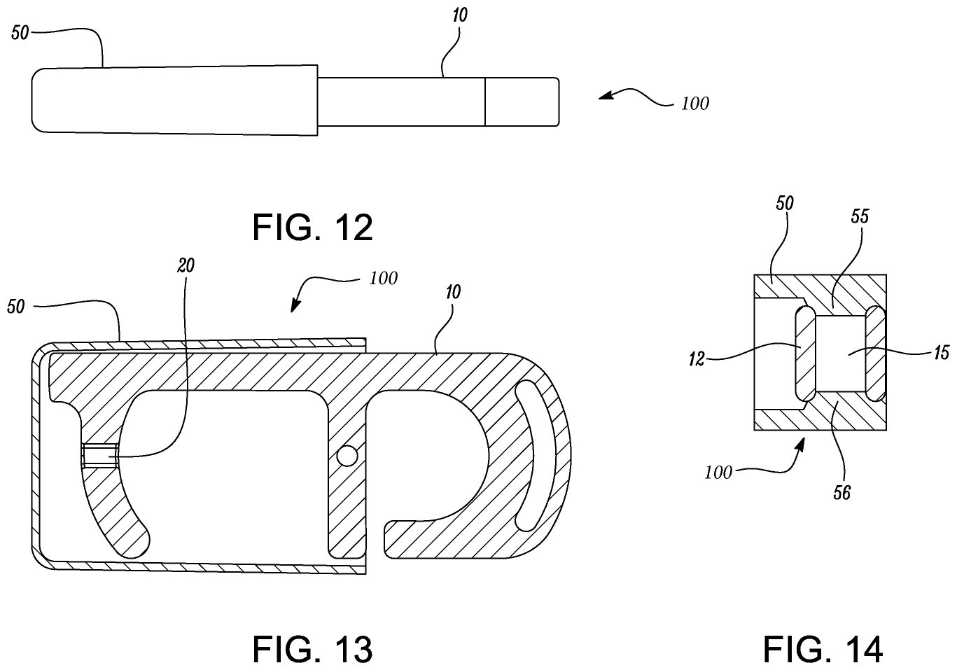

FIG. 12 is a top view of the assembled door opener multitool 100 and shows the opener member 10 snapped into the case member 50.

FIG. 13 is a cross section view of the assembled door opener multitool 100. As described above, when the opener member 10 is inserted into the case member 50, the recess 15 engages the raised members 55/56 (only one shown on FIG. 13) and retains the opener member 10 within the case member 50. While the dimensions of the opener member 10 and the case member 20 are not critical to the present invention, in the preferred embodiment, the length of the case member 50 is roughly equal to the distance between the tip 14 and the middle member 12, such that the middle member 12 is placed within the pocket 57 of the case member 50. Furthermore, in the preferred embodiment, the height of the case member 50 is roughly equal to the height of the opener member 10. Such configuration allows for a snug fit between the opener member 10 and the case member 50 and prevents the opener member 10 from rotating within the case member 50.

In alternative embodiments, the opener member 10 may be smaller than the case member 50.

In other alternative embodiments, more than a single pair of raised members 55/56 may be provided within the pocket 57 of the case member 50. In such alternative, the middle member 12 of the opener member 10 includes additional through holes corresponding to each pair of additional raised members. Such alternatives may be beneficial when a more secure fit between the opener member 10 and the case member 50 is desired.

FIG. 14 is a cross section close up view of the recess 15 of the opener member 10 and the pair of raised members 55/56 of the case member 50 of the assembled door opener multitool 100 according to the preferred embodiment of the present invention.

We claim:

1. A device comprising:
an opening member, the opening member comprising a handle, a middle member, a hook, and a tip, the handle further comprising a curved inner surface and a curved outer surface, the hook and the middle member defining an opening, and the middle member including a first recess; and
a case member, wherein the case member encloses at least a portion of the opening member, the case member including a first wall including a first raised member, wherein the first raised member is positioned to engage the first recess, and wherein the case member is configured to removably attach to the opening member.

2. The device of claim 1, wherein the recess is a through hole.

3. The device of claim 1, the middle member including a second recess located on an opposing side of the middle member, the case member including a second raised member located on a second wall on an opposing side of the case member, wherein the second raised member is positioned to engage with the second recess.

4. The device of claim 1, wherein the tip is capable of activating capacitive screens.

5. The device of claim 1, wherein the tip is blunt.

6. The device of claim 1, wherein the handle comprises a slot to attach a key ring.

7. The device of claim 1, wherein the case member encloses the hook, at least a portion of the middle member, and the tip.

8. The device of claim 1, wherein the case member is removably attached to the opening member.

9. The device of claim 1, wherein the hook includes a first channel, wherein the first channel is configured to align with the first raised member.

10. The device of claim 3, wherein the hook includes a first channel and a second channel, wherein the first channel is configured to align with the first raised member and the second channel is configured to align with the second raised member.

11. A method comprising:
receiving a device, the device comprising:
an opening member, the opening member comprising a handle, a middle member, a hook, and a tip, the handle further comprising a curved inner surface and a curved outer surface, the hook and the middle member defining an opening, and the middle member including a first recess; and
a case member, wherein the case member encloses at least a portion of the opening member, the case member including a first wall including a first raised member, wherein the first raised member is positioned to engage the first recess, and wherein the case member is configured to removably attach to the opening member; and
holding the opening member by the handle with at least one finger;
removing the opening member from the case member by applying sufficient force;
engaging a door handle using the hook of the opening member; and
attaching the opening member to the case member.

12. A device comprising:
an opening member, the opening member comprising a handle, a middle member, a hook, and a tip, the handle further comprising a curved inner surface and a curved outer surface, the hook and the middle member defining an opening, and the middle member including a first connection member; and
a case member, wherein the case member encloses at least a portion of the opening member, the case member including a first wall including a second connection member, wherein the first connection member is positioned to engage the second connection member thereby removably attaching the case member to the opening member.

13. The device of claim 12 wherein the handle comprises a slot to attach a key ring.

14. The device of claim 12, wherein the case member encloses the hook, at least a portion of the middle member, and the tip.

15. The device of claim 12, wherein the case member is comprised of a polymer containing an antibacterial component.

16. The device of claim 15, wherein the antibacterial component is a silver ion.

17. The device of claim 15, wherein the opening member is comprised of a copper alloy.
